(19) United States
(12) Patent Application Publication
(10) Pub. No.: US 2020/0055964 A1
(43) Pub. Date: Feb. 20, 2020

(54) RUBBER COMPOSITION FOR TIRE AND PNEUMATIC TIRE USING SAME

(71) Applicant: TOYO TIRE CORPORATION, Itami-shi, Hyogo (JP)

(72) Inventor: Shinya Yamamoto, Itami-shi (JP)

(73) Assignee: TOYO TIRE CORPORATION, Itami-shi, Hyogo (JP)

(21) Appl. No.: 16/348,615

(22) PCT Filed: Dec. 7, 2017
(86) PCT No.: PCT/JP2017/043967

§ 371 Date: May 9, 2019

(30) Foreign Application Priority Data
Dec. 15, 2016 (JP) 2016-243405

(51) Int. Cl. C08C 19/02; C08L 9/06; C08L 21/00; C08L 99/00; C08L 93/04; B60C 1/00

(52) U.S. Cl. CPC C08C 19/02; C08L 9/06; C08L 21/00; C08K 3/04; C08L 93/04; B60C 1/00; C08L 99/00

(57) ABSTRACT

A rubber composition for a tire that can improve processability and wet grip performance while maintaining rupture strength that is a property of a hydrogenated copolymer, and a pneumatic tire using the same, are disclosed. A rubber composition for a tire comprising a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a resin having a softening point of 60° C. or higher, wherein the resin is at least one selected from the group consisting of a petroleum resin, a phenolic resin, a rosin resin and a terpene resin.

### TECHNICAL FIELD

The present invention relates to a rubber composition for a tire and a pneumatic tire using the same.

### BACKGROUND ART

Pneumatic tire is required to have excellent grip performance on wet load surface, that is, wet grip performance. As a method for improving wet grip performance, for example, a method of using styrene-butadiene rubber (SBR) having high styrene content ratio is known.

Furthermore, a pneumatic tire is required to have excellent rupture strength, and as a method for improving rupture strength, for example, Patent Documents 1 to 5 disclose using a hydrogenated copolymer having a hydrogenation ratio of a conjugated diene moiety of 75 mol % or more, obtained by copolymerizing aromatic vinyl and a conjugated diene compound.

### PRIOR ART DOCUMENTS

### Patent Document

Patent Document 1: JP-2016-56252
Patent Document 2: JP-A-2016-56349
Patent Document 3: JP-A-2016-56350
Patent Document 4: JP-A-2016-56351
Patent Document 5: JP-A-2016-69628

### SUMMARY OF THE INVENTION

### Problems that the Invention is to Solve

However, a hydrogenated copolymer having high hydrogenation ratio has high viscosity and has the problem in processability. Furthermore, when SBR having high styrene content ratio is used to improve wet grip performance of a rubber composition using a hydrogenated copolymer, there is the problem that excellent rupture strength that is a property of a hydrogenated copolymer is not obtained.

In view of the above, the present invention has an object to provide a rubber composition for a tire that can improve processability and wet grip performance while maintaining rupture strength that is a property of a hydrogenated copolymer, and a pneumatic tire using the same.

### Means for Solving the Problems

To solve the above-described problems, the rubber composition for a tire according to the present invention comprises a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a resin having a softening point of 60° C. or higher, the resin being at least one selected from the group consisting of a petroleum rein, a phenolic resin, a rosin resin and a terpene resin.

In the rubber composition for a tire according to the present invention, the content of the resin having a softening point of 60° C. or higher can be 1 to 30 parts by mass per 100 parts by mass of the rubber component.

The pnemnatic tire according to the present invention is manufactured using the rubber composition for a tire.

### Effects of the Invention

According to the rubber composition for a tire of the present invention, a tire having improved processability and wet grip performance can be obtained while maintaining rupture strength that is a property of the hydrogenated copolymer.

### MODE FOR CARRYING OUT THE INVENTION

The items relating to the embodiment of the present invention are described in detail below.

The rubber component used in the rubber composition according to this embodiment contains a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the weight average molecular weight measured by gel permeation chromatography (GPC) is a value calculated in terms of polystyrene based on the commercially available standard polystyrene under the conditions that a differential refractive index detector (RI) is used as a detector, tetrahydrofuran (THF) is used as a solvent, a measurement temperature is 40° C., a flow rate is 1.0 mL/min, a concentration is 1.0 g/L and an injection amount is 40 μL. The hydrogenation ratio is a value calculated from a spectrum decrease rate of an unsaturated bond moiety of a spectrum obtained by measuring H¹-NMR.

The aromatic vinyl constituting the aromatic vinyl-conjugated diene copolymer is not particularly limited, but examples thereof include styrene, α-methylstyrene, 1-vinylnaphthalene, 3-vinyltoluene, ethylvinylbenzene, divinylbenzene, 4-cyclohexylstyrene and 2,4,6-trimethylstyrene. Those may be used alone or as a combination of two or more kinds.

The conjugated diene constituting the aromatic vinyl-conjugated diene copolymer is not particularly limited, but examples thereof include 1,3-butadiene, isoprene, 1,3-pentadiene, 2,3-dimethylbutadiene, 2-pheny-1,3-butadiene and 1,3-hexadiene. Those may be used alone or as a combination of two or more kinds.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer. The aromatic vinyl-conjugated diene copolymer may be modified with at least one functional group selected from the group consisting of amino group, hydroxyl group, epoxy group, alkoxy group, alkylsilyl group, alkoxysilyl group and carboxyl group at a molecular end or in a molecular chain.

The hydrogenated copolymer can be synthesized by, for example, synthesizing an aromatic vinyl-conjugated diene copolymer and conducting a hydrogenation treatment. A method for synthesizing the aromatic vinyl-conjugated diene copolymer is not particularly limited, but the examples thereof include a solution polymerization method, a gas phase polymerization method and a bulk polymerization method, and a solution polymerization method is preferred. The polymerization form may be any of a batch type and a continuous type. The aromatic vinyl-conjugated diene copolymer can use the commercially available copolymers.

The hydrogenation method is not particularly limited, and the aromatic vinyl-conjugated diene copolymer is hydrogenated by the conventional method under the conventional conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, a reaction time and the like. The hydrogenation catalyst can generally use a compound containing any of metals of Groups 4 to 11 of the periodic table. For example, a compound containing Ti, V, Co, Ni, Zr, Ru, Rh, Pd, Hf, Re or Pt atom can be used as the hydrogenation catalyst. Examples of more specific hydrogenation catalysts include a metallocene compound such as Ti, Zr, Hf, Co, Ni, Pd, Pt, Ru, Rh or Re; a supported type heterogeneous catalyst comprising a carrier such as carbon, silica, alumina or diatomaceous earth and a metal such as Pd, Ni, Pt, Rh or Ru supported thereon; a homogeneous Ziegler catalyst comprising a combination of an organic salt or acetylacetone salt of a metal element such as Ni or Co and a reducing agent such as organic aluminum; an organic metal compound or complex of Ru or Rh; and fullerene or carbon nanotube having hydrogen occluded therein.

The hydrogenation ratio of the hydrogenated copolymer (proportion of hydrogenated moiety in conjugated diene moiety of aromatic vinyl-conjugated diene copolymer) is 80 mol % or more and preferably 90 mol % or more. When the hydrogenation ratio is 80 mol % or more, the improvement effect of rupture strength and abrasion resistance due to homogenization of crosslinking is excellent.

The weight average molecular weight of the hydrogenated copolymer is not particularly limited so long as it is 300,000 or more. The weight average molecular weight is preferably 300.000 to 2,000,000, more preferably 300,000 to 1,000,000 and still more preferably 300,000 to 600,000.

The rubber component may contain a diene rubber other than the hydrogenated copolymer, and examples of the diene rubber include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content ratio of the hydrogenated copolymer in the rubber component is not particularly limited, but, is preferably 80 to 100 mass % and more preferably 90 to 100 mass %.

In the rubber composition of this embodiment, a petroleum resin, a phenolic resin, a rosin resin and a terpene resin can be used as the resin having a softening point of 60° C. or higher, and those resins may be hydrogenated resins. Those resins may be used in one kind alone and may be used as a combination of two or more kinds. The softening point is not particularly limited so long as it is 60° C. or higher, but is preferably 60 to 150° C. The softening point used herein means a value measured according to JIS K6220. When the softening point is 60° C. or higher, the improvement effect of processability is excellent.

The petroleum resin is not particularly limited, and examples thereof include an aliphatic petroleum resin, an aromatic petroleum resin and an aliphatic/aromatic copolymer type petroleum resin. Those may be used in one kind alone and may be used as a combination of two or more kinds. The aliphatic petroleum resin can use a resin (called C5 petroleum resin) obtained by cationically polymerizing an unsaturated monomer such as isoprene and cyclopentadiene that are petroleum fraction (C5 fraction) containing 4-5C compounds. The aromatic petroleum resin can use a resin (called C9 petroleum resin) obtained by cationically polymerizing a monomer such as vinyltoluene, alkyl styrene and indene that are a petroleum fraction (C9 fraction) containing 8-10C compounds. The aliphatic/aromatic copolymer type petroleum resin can use a resin (called C5/C9 petroleum resin) obtained by copolymerizing the C5 fraction and the C9 fraction.

The phenolic resin is not particularly limited, but examples thereof include a phenol-formaldehyde resin, an alkyl phenol-formaldehyde resin, an alkyl phenol-acetylene resin and an oil-modified phenol-formaldehyde resin.

The rosin resin is not particularly limited, but examples thereof include natural resin rosin and a rosin-modified resin obtained by modifying the natural resin rosin by hydrogenation, disproportionation, dimerization, esterification or the like.

The terpene resin is not particularly limited, but examples thereof include polyterpene and a terpene-phenol resin.

The content of the resin having the softening point of 60° C. or higher (total amount when using two or more kinds) is not particularly limited, but is preferably 1 to 30 parts by mass, more preferably 1 to 20 parts by mass and still more preferably 3 to 15 parts by mass, per 100 parts by mass of the rubber component. When the resin content is 1 part by mass or more, the improvement effect of processability is excellent, and when the resin content is 30 parts by mass or less, rupture strength is excellent.

In the rubber composition according to this embodiment, carbon black and/or silica can be used as the reinforcing filler. In other words, the reinforcing filler may be carbon black alone, may be silica alone and may be a combination of carbon black and silica. A combination of carbon black and silica is preferably used. The content of the reinforcing filler is not particularly limited, and is, for example, preferably 10 to 150 parts by mass, more preferably 20 to 100 parts by mass and still more preferably 30 to 80 parts by mass, per 100 parts by mass of the rubber component.

The carbon black is not particularly limited and conventional various kinds can be used. The content of the carbon black is preferably 1 to 70 parts by mass and more preferably 1 to 30 parts by mass, per 100 parts by mass of the rubber component.

The silica is not particularly limited, but wet silica such as wet precipitated silica or wet gelled silica is preferably used. When the silica is contained, its content is preferably 10 to 100 parts by mass and more preferably 15 to 70 parts by mass, per 100 parts by mass of the rubber component from the standpoints of balance of tan 8 of rubber, reinforcing properties and the like.

When the silica is contained, a silane coupling agent such as sulfide silane or mercaptosilane may be further contained. When the silane coupling agent is contained, its content is preferably 2 to 20 mass % based on the silica content.

In addition to the above components, compounding ingredients used in general rubber industries, such as a process oil, zinc flower, stearic acid, a softener, a plasticizer, a wax, an age resister, a vulcanizing agent and a vulcanization accelerator can be appropriately added in the general range to the rubber composition according to this embodiment.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the rubber component. The content of the vulcanization accelerator is preferably 0.1 to 7 parts by mass and more preferably 0.5 to 5 parts by mass, per 100 parts by mass of the rubber component.

The rubber composition according to this embodiment can be produced by kneading the necessary components according to the conventional method using a mixing machine generally used, such as Banbury mixer, a kneader or rolls. Specifically, additives excluding a vulcanizing agent and a vulcanization accelerator are added to the rubber component together with the resin having a softening point of 60° C. or higher, followed by mixing, in a first mixing step, and a vulcanizing agent and a vulcanization accelerator are added to the mixture obtained, followed by mixing, in a final mixing step. Thus, a rubber composition can be prepared.

The rubber composition thus obtained can be used for a tire and can be applied to each site of a tire, such as a tread part or a sidewall part of pneumatic tires having various uses and sizes, such as tires for passenger cars or large-seize tires for trucks or buses. The rubber composition is molded into a predetermined shape by, for example, extrusion processing according to the conventional method, combined with other parts and then vulcanized at, for example, 140 to 180° C. Thus, a pneumatic tire can be manufactured.

The kind of the pneumatic tire according to this embodiment is not particularly limited, and examples of the pneumatic tire include various tires such as tires for passenger cars and heavy load tires for trucks, buses and the like.

### EXAMPLES

Examples of the present invention are described below, but the present invention is not construed as being limited to those examples.

### Synthesis Example 1 of Hydrogenated Copolymer

2.5 L of cyclohexane, 50 g of tetrahydrofuran, 0.12 g of n-butyl lithium, 100 g of styrene and 400 g of 1,3-butadiene were put in a nitrogen-substituted heat-resistant reactor, and polymerization was conducted at a reaction temperature of 50° C. After completion of the polymerization, 1.7 g of N,N-bis(trimethylsilyl)aminopropylmethyl diethoxysilane was added, a reaction was conducted for 1 hour and hydrogen gas was then supplied under a pressure of 0.4 MPa-gauge. The reaction was conducted at a reaction temperature of 90° C. under a hydrogen gas supply pressure of 0.7 MPa-gauge using a catalyst mainly comprising titanocene dichloride until reaching a target hydrogenation ratio. Solvent was removed to obtain hydrogenated copolymer 1.

The hydrogenated copolymer obtained had a weight average molecular weight by GPC of 350.000 in terms of polystyrene by standard polystyrene. The measurement was conducted using “LC-10A” manufactured by Shimadzu Corporation as a measuring instrument using “PLgel-MIXED-C” manufactured by Polymer Laboratories as a column, using a differential refractive index detector (RI) as a detector and using THF as a solvent under the conditions that a measurement temperature is 40° C., a flow rate is 1.0 mL/min, a concentration is 1.0 g/L and an injection amount is 40 μL. The amount of bonded styrene was 20 mass % and the hydrogenation ratio of the butadiene moiety was 90 mol %. The amount of the bonded styrene was obtained from a spectrum intensity ratio of proton based on styrene unit and proton based on butadiene unit (containing hydrogenated moiety) using H¹-NMR.

### Synthesis Example 2 of Hydrogenated Copolymer

Hydrogenated copolymer 2 was obtained by the same method as Synthesis Example 1, except for changing the reaction time for hydrogenation and changing the target hydrogenation ratio. The hydrogenated copolymer 2 obtained had a weight average molecular weight of 350,000 in terms of polystyrene by standard polystyrene. The amount of bonded styrene was 20 mass % and the hydrogenation ratio of the butadiene moiety was 80 mol %.

### Examples and Comparative Examples

Using a Banbury mixer, components excluding a vulcanization accelerator and sulfur were added according to the formulations (parts by mass) shown in Table 1 below, followed by mixing, in a first mixing step (non-processing kneading step) (discharge temperature: 160° C.). A vulcanization accelerator and sulfur were added to the mixture obtained, followed by mixing, in a final mixing step (processing kneading step) (discharge temperature: 90° C.). Thus, a rubber composition was prepared.

The details of each component in Table 1 are as follows.

Hydrogenated SBR 1: Hydrogenated copolymer 1 prepared according to Synthesis Example 1

Hydrogenated SBR 2: Hydrogenated copolymer 2 prepared according to Synthesis Example 2

SBR: “SBR0122” manufactured by JSR Corporation, mass ratio of styrene to vinyl group in butadiene moiety (styrene/vinyl group in butadiene moiety)=37/14

Silica: “Ultrasil VN3” manufactured by Evonik

Carbon black: “SEAST 3” manufactured by Tokai Carbon Co., Ltd.

Oil: “PROCESS NC140” manufactured by JX Nippon Oil & Sun Energy Corporation

Resin 1: Coumarone-indene resin, “NOVARES C30” manufactured by Rutgers Chemicals, softening point-20 to 30° C.

Resin 2: C5/C9 resin, “TOHO HIRESIN” manufactured by Toho Chemical Industry Co., Ltd., softening point=95 to 103° C.

Resin 3: Phenolic resin, “SP1068” manufactured by Nippon Shokubai Co., Ltd., softening point=−82 to 100° C.

Resin 4: Rosin resin. “HARIMACK T-90” manufactured by Harima Chemicals Group, Inc., softening point=80 to 90° C.

Resin 5: Terpene resin “TP115” manufactured by Arizona Chemical, softening point=115° C.

Zinc flower: “Zinc Flower #3” manufactured by Mitsui Mining & Smelting Co., Ltd.

Stearic acid: “LUNAC S-20” manufactured by Kao Corporation

Age resister: “NOCRAC 6C” manufactured by Ouchi Shinko Chemical Industrial Co., Ltd.

Wax: “OZOACE 0355” manufactured by Nippon Seiro Co., Ltd.

Silane coupling agent: “Si69” manufactured by Evonik

Sulfur: “Powdered Sulfur” manufactured by Tsurumi Chemical Industry Co., Ltd.

Vulcanization accelerator 1: “NOCCELER D” manufactured by Ouchi Shinko Chemical Industrial Co., Ltd.

Vulcanization accelerator 2: “SOXINOL CZ” manufactured by Sumitomo Chemical Co., Ltd.

Processability, rupture strength and wet grip performance of each composition obtained were evaluated. The evaluation methods were as follows.

Processability: An unvulcanized rubber discharged in the final mixing step was formed into a sheet shape by 8-inch rolls, and the state of the surface and both ends of the sheet was observed. The sheet having the state that the surface and both ends are smooth was indicated as “∘”, and the sheet corresponding to at least one of the state that the surface is rugged and the state that both ends are jagged was indicated as “x”.

Rupture strength: Using a test piece having a predetermined shape obtained by vulcanizing the rubber composition obtained at 160° C. for 30 minutes, a tensile test (Dumbbell-shaped 3) was conducted according to JIS K6251 and stress at break was measured. The rupture strength was indicated by an index as the value of Comparative Example 1 being 100. Larger value indicates high rupture strength.

Wet grip performance: Using a test piece having a predetermined shape obtained by vulcanizing the rubber composition obtained at 160° C. for 30 minutes, Lupke rebound resilience test was conducted according to JIS K6255 and modulus of repulsion elasticity at 23° C. was measured. The results were shown by an index in terms of the inverse value of the modulus of repulsion elasticity obtained as the value of Comparative Example 1 being 100. Larger index indicates excellent wet grip performance.

TABLE 1

| | Com. | Com. | Com. | Com. | | | | | | |
|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 |
| Hydrogenated SBR 1 | 100 | 100 | 100 | 70 | 100 | 100 | 100 | 100 | 100 | — |
| Hydrogenated SBR 2 | — | — | — | — | — | — | — | — | — | 100 |
| SBR | — | — | — | 30 | — | — | — | — | — | — |
| Silica | 60 | 60 | 75 | 60 | 60 | 60 | 60 | 60 | 60 | 60 |
| Carbon black | 5 | 5 | 5 | 5 | 5 | 5 | 5 | 5 | 5 | 5 |
| Oil | 15 | 10 | 25 | 15 | 10 | 5 | 10 | 10 | 10 | 10 |
| Resin 1 | — | 5 | — | — | — | — | — | — | — | — |
| Resin 2 | — | — | — | — | 5 | 10 | — | — | — | 5 |
| Resin 3 | — | — | — | — | — | — | 5 | — | — | — |
| Resin 4 | — | — | — | — | — | — | — | 5 | — | — |
| Resin 5 | — | — | — | — | — | — | — | — | 5 | — |
| Zinc flower | 3 | 3 | 3 | 3 | 3 | 3 | 3 | 3 | 3 | 3 |
| Stearic acid | 2 | 2 | 2 | 2 | 2 | 2 | 2 | 2 | 2 | 2 |
| Age resister | 2 | 2 | 2 | 2 | 2 | 2 | 2 | 2 | 2 | 2 |
| Wax | 2 | 2 | 2 | 2 | 2 | 2 | 2 | 2 | 2 | 2 |
| Silane coupling agent | 5 | 5 | 5 | 5 | 5 | 5 | 5 | 5 | 5 | 5 |
| Sulfur | 2 | 2 | 2 | 2 | 2 | 2 | 2 | 2 | 2 | 2 |
| Vulcanization accelerator 1 | 1.5 | 1.5 | 1.5 | 1.5 | 1.5 | 1.5 | 1.5 | 1.5 | 1.5 | 1.5 |
| Vulcanization accelerator 2 | 1.5 | 1.5 | 1.5 | 1.5 | 1.5 | 1.5 | 1.5 | 1.5 | 1.5 | 1.5 |
| Processability | X | X | ◯ | ◯ | ◯ | ◯ | ◯ | ◯ | ◯ | ◯ |
| Rupture strength | 100 | 97 | 87 | 71 | 97 | 95 | 97 | 98 | 98 | 95 |
| Wet grip performance | 100 | 103 | 110 | 104 | 111 | 119 | 114 | 121 | 116 | 113 |

The results are shown in Table 1. It is recognized from the comparison between Comparative Example 1 and Examples 1 to 6 that when the resin having a softening point of 60° C. or higher is contained, processability and wet grip performance are improved while maintaining rupture strength that is a property of the hydrogenated copolymer.

It is understood from the comparison between Comparative Example 1 and Comparative Example 2 that even when the resin having a softening point of less than 60° C. is contained, processability is not improved.

It is understood from the comparison between Comparative Example 1 and Comparative Example 3 that when the amount of the silica and oil is increased, rupture strength is deteriorated.

Furthermore, it is understood from the comparison between Comparative Example 1 and Comparative Example 4 that when a part of the hydrogenated SBR is substituted with SBR having high styrene content ratio, rupture strength is deteriorated.

### INDUSTRIAL APPLICABILITY

The rubber composition for a tire of the present invention can be used in various tires of passenger cars, light trucks, buses and the like.

1. A rubber composition for a tire comprising:
a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and
a resin having a softening point of 60° C. or higher,
wherein the resin is at least one selected from the group consisting of a petroleum resin, a phenolic resin, a rosin resin and a terpene resin.

2. The rubber composition for a tire according to claim 1, wherein the content of the resin having a softening point of 60° C. or higher is 1 to 30 parts by mass per 100 parts by mass of the rubber component.

3. A pneumatic tire manufactured using the rubber composition for a tire according to claim 1.

4. A pneumatic tire manufactured using the rubber composition for a tire according to claim 2.
